(19) United States
(12) Patent Application Publication
(10) Pub. No.: US 2015/0142155 A1
(43) Pub. Date: May 21, 2015

(54) Holding and Transporting Device

(71) Applicant: Manuela Braun, (US)

(72) Inventor: Fabian Loges, Dusseldorf (DE)

(21) Appl. No.: 14/413,719

(22) PCT Filed: Jul. 8, 2013
(86) PCT No.: PCT/EP2013/002006

§ 371 Date: Jan. 9, 2015

(30) Foreign Application Priority Data
Jul. 9, 2012 (DE) 20 2012 006 529.7

(51) Int. Cl. G05B 19/418

(52) U.S. Cl. CPC G05B 19/4189; G05B 2219/50333
USPC 700/112

(57) ABSTRACT

The invention relates to a holding and transporting device for intermediate products (10), in particular for boards heated for hot forming or pre-formed shaped components, having at least one tactile temperature measuring sensor (6), which is integrated in the holding and transporting device in such a way that the sensor is in touching contact with the intermediate product (10) during the transport. The tactile temperature measuring sensor (6) for contacting the intermediate product (10) is preferably held such that it can be displaced resiliently counter to an elastic preload. In particular, the holding and transporting device has at least one gripper having an abutment (2) and a gripper element (3) that can be moved with respect to the latter, wherein the temperature measuring sensor (6) is arranged on the abutment (2).

The invention concerns a holding and transporting device according to the preamble of claim 1. These are used in particular in production lines of press hardening processes and transport intermediate products that are heated, in particular have been austenized, between the furnace exit and a forming tool into which they are inserted. The intermediate products are in particular plates of sheet metal or already partially preformed shaped components as well as the semi-finished products generated by the forming step prior to finish processing.

It is desirable to obtain information in particular in regard to the removal temperature of the plate from the furnace up to the insertion into the forming tool in order to discover early on processing errors as well as to minimize the reject rate. For this purpose, in practice optical pyrometers or thermographic cameras are already sporadically installed at the furnace exit and/or in the press in order to detect the temperatures at these locations. It is however disadvantageous in this context that measurements are possible only at certain points at the respective locations and at the points in time at which the intermediate product is present at these locations. Also, the measuring precision depends very strongly on the emission factor of the intermediate product. The emission factor differs from plate to plate because of the layer peculiarity as a function of the furnace temperature and the furnace residence time so that usually no precise information in regard to the emission factor is available. In workpieces with differently tempered areas, the measuring deviations are all the greater because, as a result of the different temperature profiles, different emission factors are existing on a plate and can be determined only by means of drag measurements performed beforehand and must then be compared with the optical temperature detection system. This is very complex.

The object of the invention is therefore to enable an improved and/or simplified temperature measurement of the intermediates products. This object is solved by means of a holding and transporting device with the features of claim 1.

By integration of at least one tactile temperature measuring sensor, i.e, measuring by contacting, into the holding and transporting device that transports the intermediate product in particular from the furnace to the hot forming process, for example, to the press hardening die, temperature data of the intermediate product can be recorded during the entire transport so that it is possible to make a determination not only in regard to the temperature of the intermediate product at the time of leaving the furnace and/or at the time of inserting into the die, but also in the time in between. Due to tactile measurement, these data are independent of the emission rate of the workpiece and therefore significantly more precise, without this requiring prior detection of the emission rate. In order to record temperature data at different points of the workpiece or to achieve reliability by double measurements, it is also possible to provide several temperature measuring sensors. When in the following as a simplification “one” or “the” temperature measuring sensor is mentioned, this is always meant to encompass also embodiments with several sensors.

Since during the transport of the intermediate product the holding and transporting device always contacts the intermediate product at least with one contact area, the use of a tactile temperature measuring sensor is always possible. By means of the information generated thereby, an efficient process monitoring action or process control can be configured that is independent of the surface properties of the plate or of the workpiece. By means of a tactile temperature measuring sensor, high measuring precision and repetition precision with measuring deviations of <=1.5% and short response times of maximally 2 seconds can be achieved. In particular for workpieces with different temperature areas, holding and transporting devices furnished in accordance with the invention have a great advantage because, in particular for these components, flaws can be detected early on by temperature monitoring and can be assigned to individual process steps.

It is particularly advantageous when the tactile temperature measuring sensor for contacting the intermediate product is slidably secured against an elastic pretension in or on the holding and transporting device, in particular is spring-pretensioned but yielding. In this way, it can be ensured that the temperature measuring sensor always contacts the workpiece, even in case of surface and/or shape deviations.

Holding and transporting devices of the afore described kind are often configured on a robot arm as a gripper with a movable gripper element or a movable gripper jaw and a support that is rigid relative thereto. For such holding and transporting devices it is advantageous to arrange the temperature measuring sensor on an area that is not moving during transport relative to the intermediate product, in this context the support, because connections, cable inlet lines, etc. then must not be designed to be movable.

Preferably, the temperature measuring sensor is connected to an evaluation unit that is integrated into or connected as a separate device to the holding and transporting device and that, for example, may serve for recording the temperature values, for determining limit ranges, for issuing a warning upon surpassing limit ranges etc.

In an advantageous way, at least one contactless temperature measuring sensor can be integrated additionally in the holding and transporting device. With it, information in regard to the emission factor of the workpiece can be obtained by comparison with the values of the tactile temperature measuring sensor, without this requiring complex drag measurements. The determination of the emission factor can be realized fully automatically when the tactile as well as the contactless temperature measuring sensor are connected with an evaluation unit as described above.

Independent of whether the evaluation unit is supplied with data of one temperature measuring sensor or several temperature measuring sensors, it is particularly advantageous when the evaluation unit is connected with a control unit or control device by means of which the transport of the intermediate product or of the plate can be affected. For example, products whose measured temperature indicates a reject product can be sorted out prior to the further forming step without having to invest into further processing steps. However, should only the temperature be too high, the transport can be slowed down so that the components are placed with always the same temperature into the forming tool.

The holding and transporting device according to the invention can be produced in a cost-efficient way. Also, tactile temperature measuring sensors can be integrated in a simple way into the handling or gripper system. This is even possible by attachment on already existing holding and transport devices so that the latter can be retrofitted.

Further advantages and details result from the claims and the embodiments of the invention that are illustrated in the drawings and will be described in the following. It is shown in:

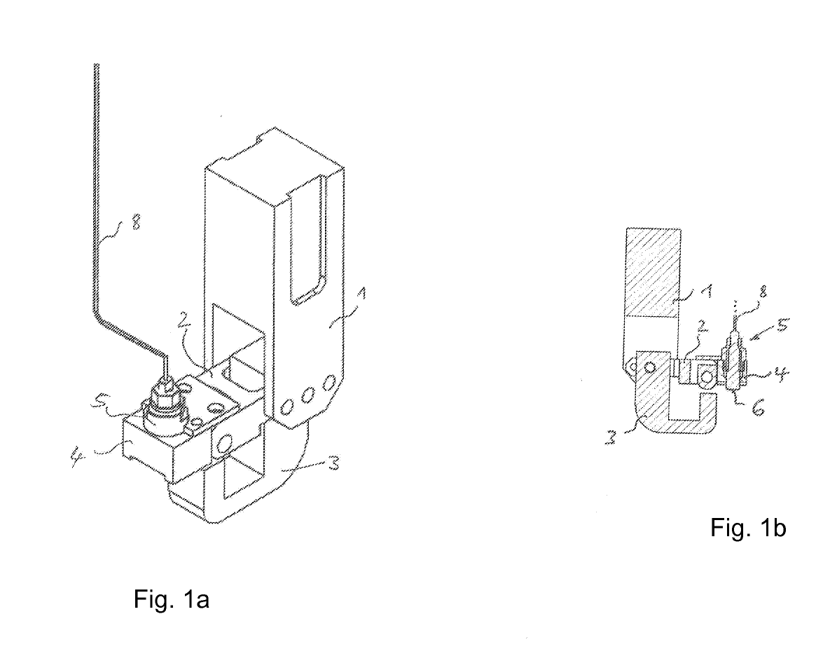

FIG. 1 the holding element of a holding and transporting device according to the invention, in a perspective view and in section;

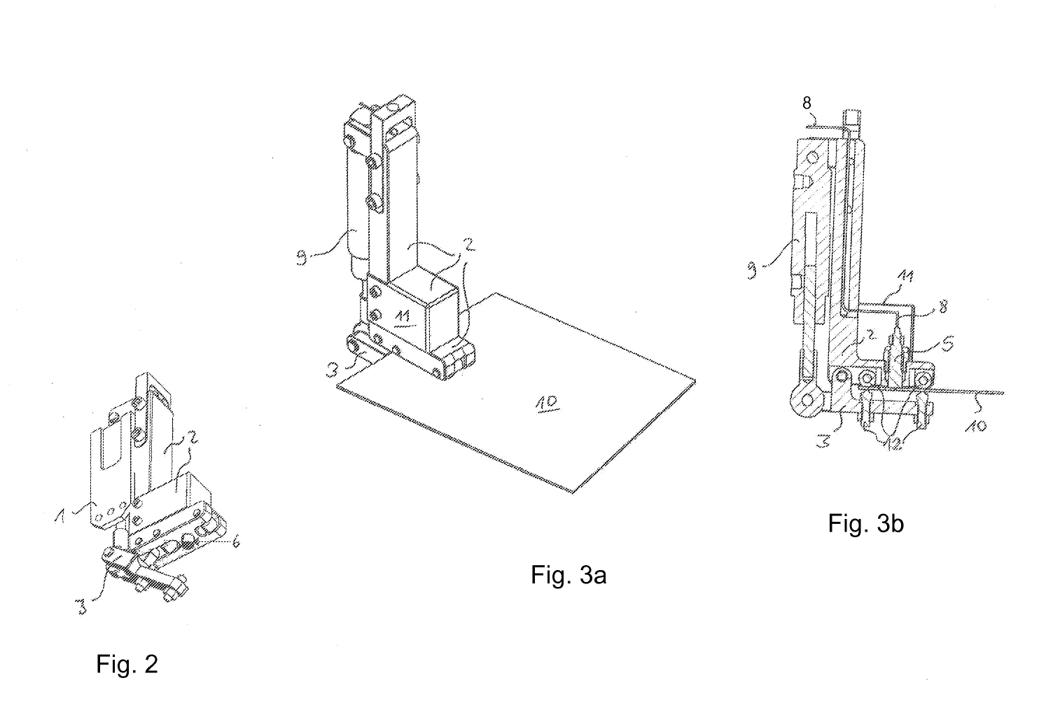

FIG. 2 another embodiment of a holding element of a holding and transporting device, in a perspective view and open;

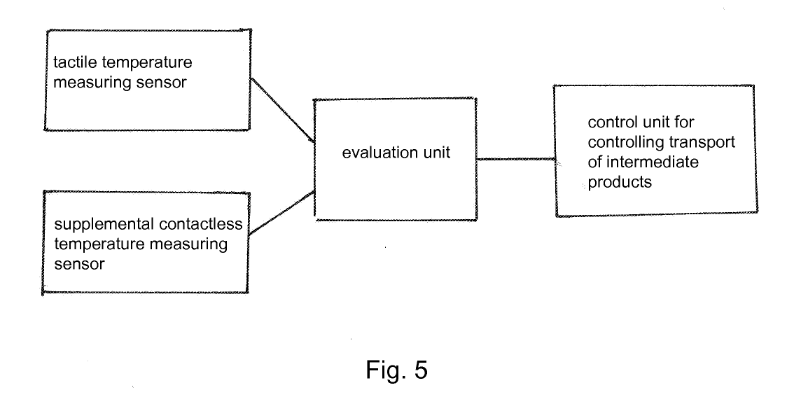

FIG. 3 the object of FIG. 2 with received plate, in a perspective view and in section; and

FIG. 4 the object of FIGS. 2 and 3 while receiving a plate.

FIG. 1 shows the gripper or one of the grippers of a holding and transporting device embodied as a conventional robot with a gripper receptacle 1 with integrated pneumatic cylinder, an upper gripping jaw 2 rigid relative thereto, and a lower gripping jaw 3 which herein is pivotable. The illustrated embodiment concerns a retrofitted version wherein on the upper gripping jaw 2 a holder 4 for the tactile temperature measuring instrumentation 5 is attached which is connected by means of a thermocouple 7 (preferably of the type K) to the robot arm. The tactile temperature measuring instrumentation 5 comprises a tactile temperature measuring sensor 6 which is projecting past the bottom side of the upper gripper jaw 2 in downward direction and therefore, when a plate is received, comes into contact therewith.

FIGS. 2 and 3 show another embodiment of a gripper wherein for corresponding components same reference numerals are used. Instead of a gripper receptacle with integrated hydraulic cylinder, a pneumatic cylinder 9 connected to the upper gripper jaw 2 is provided for actuating the movable lower gripper jaw 3. Between the two gripper jaws 2, 3 the plate 10 is received. The tactile temperature measuring instrumentation 5 is not attached to a gripper jaw along its extension but is completely integrated into the upper gripper jaw 2. FIG. 3a shows that the instrumentation and its thermocouple 8 can be covered by a housing part 11. As shown in FIG. 3b, the upper and the lower gripper jaws 2, 3 for receiving the plate 10 comprise contact elements 12 that preferably are provided with a minimal contact surface so that the plate 10 in the holding area is cooled as little as possible due to the direct contact of the contact elements 12. The temperature measuring sensor 6 of this embodiment is spring-preloaded and is attached to be slidable in vertical direction which will be explained in the following with the aid of FIG. 4 in connection with the process sequence of gripping the plate.

In method step I, the entire gripper is moved linearly in Z direction toward the plate 10 with the lower gripper jaw 3 being in open position. In method step II, the tactile temperature measuring instrumentation 5 with its sensor 6 contacts the plate 10 and begins to record the temperature. In method step II, the gripper system contacts the plate 10 with the upper gripper jaw 2 and has reached its lowermost contact point in Z direction. In doing so, the tactile temperature measuring instrumentation 5 with its sensor 6 has been displaced against a spring action into the upper gripper jaw 2 but is still completely resting on the plate 10. In method step IV, the lower gripper jaw 3 is finally closed by pivoting in the direction of the arrow. It then ensures an optimal position and fixation of the plate 10 so that the temperature measurement during transport is not affected in a disadvantageous way.

Both embodiments concern only examples; many modifications are possible. In particular, the embodiments and holding and transporting device differently furnished but still in accordance with the invention can be supplemented, as claimed, with a contactless temperature sensor means as has been also explained above as being advantageous.

The device according to the invention is advantageously also usable for temperature monitoring not only between furnace and pressing die but also for already formed intermediate products after leaving the forming device. In this context, they can monitor as removal robots the limit temperature of the component which must not be surpassed upon removal from the die in order not to produce later on impermissibly high shrinkage, for example. For example, when the limit removal temperature is set to 200° C. and when, by the sensor means of the device according to the invention, a higher temperature is determined, it is possible to react immediately for the subsequent component in that the latter is kept somewhat longer in the die for further cooling. Accordingly, the production quality can be further increased.

What is claimed is:

1.-7. (canceled)

8. A holding and transporting device for intermediate products, the device comprising at least one tactile temperature measuring sensor configured such that, during transport of an intermediate product by the holding and transporting device, the at least one tactile temperature measuring sensor is in tactile contact with the intermediate product.

9. The holding and transporting device according to claim 8, wherein, for contacting the intermediate product, the at least one tactile temperature measuring sensor is slidably yieldingly secured against an elastic pretension.

10. The holding and transporting device according to claim 8, further comprising at least one gripper comprising a support and a gripper element movable relative to the support, wherein the at least one tactile temperature measuring sensor is arranged on the support.

11. The holding and transporting device according to claim 8, further comprising at least one supplemental contactless temperature measuring sensor.

12. The holding and transporting device according to claim 8, further comprising an evaluation unit, wherein the at least one tactile temperature measuring sensor is connected to the evaluation unit.

13. The holding and transporting device according to claim 12, further comprising at least one supplemental contactless temperature measuring sensor, wherein the at least one supplemental contactless temperature measuring sensor is connected to the evaluation unit, wherein the evaluation unit is adapted to perform a comparison of an emission factor of the intermediate product.

14. The holding and transporting device according to claim 12, further comprising a control unit configured to control transport of the intermediate product by the holding and transporting device, wherein the evaluation unit is connected to the control unit in order to affect transport as a function of a temperature measured by the at least one tactile temperature measuring sensor.
